(19) United States
(12) Patent Application Publication
(10) Pub. No.: US 2018/0044917 A1
(43) Pub. Date: Feb. 15, 2018

(54) PREFABRICATED PANEL FORMWORK, SUITABLE FOR BEING USED IN THE CONSTRUCTION OF BUILDINGS AND GARDENS

(71) Applicant: Sergio MARINELLI, Jesi (AN) (IT)

(72) Inventor: Sergio MARINELLI, Jesi (AN) (IT)

(21) Appl. No.: 15/554,512

(22) PCT Filed: Mar. 9, 2016
(86) PCT No.: PCT/EP2016/054634

§ 371 Date: Aug. 30, 2017

(30) Foreign Application Priority Data
Mar. 9, 2015 (IT) AN2015A000040

(51) Int. Cl. E04B 2/86; A01G 9/02

(52) U.S. Cl. CPC E04B 2/8658; A01G 9/025; E04B 2/8652

(57) ABSTRACT

Prefabricated panel formwork, suitable for being used in the construction of buildings and gardens. Pre-fabricated panel formwork provided with a pair of vertical metal sections to which a back metal wall and a front metal wall are fixed, being suitable to define an intermediate cavity that is open on top and on the bottom; wherein at least said front metal wall is provided with a plurality of horizontal slots, each of them being positioned at the top of an underneath pocket that protrudes frontally from the same wall.

The present patent application for industrial invention relates to a panel formwork that is suitable for being used in the construction of buildings and gardens.

The peculiarities and advantages of the present invention will become more apparent following a short description of the prior art.

Following is a brief illustration of the traditional methods used to make concrete casting in order to obtain reinforced concrete structures, such as buildings, retaining walls, bridges and the like.

In such circumstances a formwork is prepared, which will receive a concrete casting and give the desired shape to concrete after setting; it being also provided that the space comprised in said formwork has been previously equipped with the irons intended to be drowned in the concrete casting to provide reinforcement.

In the majority of cases the formworks of this type are prepared by carpenters with wooden boards or steel panels that are intended to form the walls of the formwork.

Moreover, the boards or panels forming the two opposite vertical walls of a typical formwork are joined by means of horizontal plates, basically consisting in tie-rods, which are interposed between them and intended to be embedded in the concrete casting after the concrete has set and the vertical walls of the formwork have been removed.

In spite of its large diffusion, such a technology is impaired by some drawbacks.

The first drawback is represented by the complexity of the carpentry operations that are needed to place each formwork in position and to remove the walls of the formwork when the concrete has set.

It is worthless noting that these two activities are time-consuming and expensive in terms of labor costs.

An additional problem is represented by the fact the, after being completely removed from the formwork, the concrete casting shows its typical structure, which is not aesthetically pleasing and therefore requires to be finished or covered with a surface coating.

The new formwork of the invention has been devised starting from the observation of said drawbacks, its main peculiarity being that it has a prefabricated structure that is fully disposable and intended to remain joined to the concrete casting, without removing its parts as in the prior art.

In particular, it is composed of two vertical metal sections disposed at its ends, in correspondence of which the walls that cover the front and the back of the formwork are fixed; it being also provided that the space comprised between the two walls, i.e. the space intended to receive and contain the concrete casting, is suitably reinforced with the irons that are intended to be embedded in the concrete.

An additional peculiarity of the prefabricated formwork of the invention is that at least one of its vertical walls is directly obtained with a metal plate that is suitably finished on the front and is therefore intended to act as an aesthetically-pleasant finish for the concrete casting after setting.

Preferably, the coating sheet is obtained with an expanded metal plate, of the type provided with a regular set of horizontal slots that, when the metal plate is expanded, are practically shaped as pockets (substantially being protruding ashlars) that are open on top and protrude frontally from the metal plate.

In such a situation it can be well understood that the concrete casting made inside the latter version of the formwork according to the invention is intended to flow outside through said horizontal openings provided at the top of the pockets while the formwork is filled with concrete.

Such an effect can be used for ornamental purposes, especially when inert materials of any desired color are added to the concrete casting and the concrete flowing outside in fluid state through the slots of the metal plate is removed and cleaned before setting.

In other words, the concrete casting still in fluid state must be leveled in correspondence of each of said slots provided in said pockets of the metal plate.

In this way, after setting inside the formwork of the invention, the concrete casting remains visible through the slots of the metal plate, showing its color and chromatically decorating both the metal plate and the entire formwork of the invention.

Nevertheless, as anticipated in the title of this patent application, the prefabricated formwork of the invention can be also used for the construction of gardens, and more particular of the so-called “vertical” gardens.

This expression is used to identify vertical surfaces intended to be provided with flowers and plants until they are either completely or largely covered.

In such a context the formwork of the invention as described above is filled with soil until said front pockets are completely filled with it.

Also in this case, the soil “coming out” through the horizontal slots of said pockets must be suitably leveled and used as soil to grow climbing plants, small hedges, short-stemmed flowers and the like.

In fact, while growing, these vegetable varieties tend to take more and more space and become very visible on the front of the formwork according to the present invention, thus creating in the observer the impression of being in front of an entirely vegetable panel or barrier.

Moreover, it must be considered that, when it is filled with soil, the formwork of the invention acquires advantageously good sound-absorbing properties.

For purposes of clarity the description of the formwork according to the present invention continues with reference to the attached drawings, which are intended for purposes of illustration only, and not in a limiting sense, wherein:

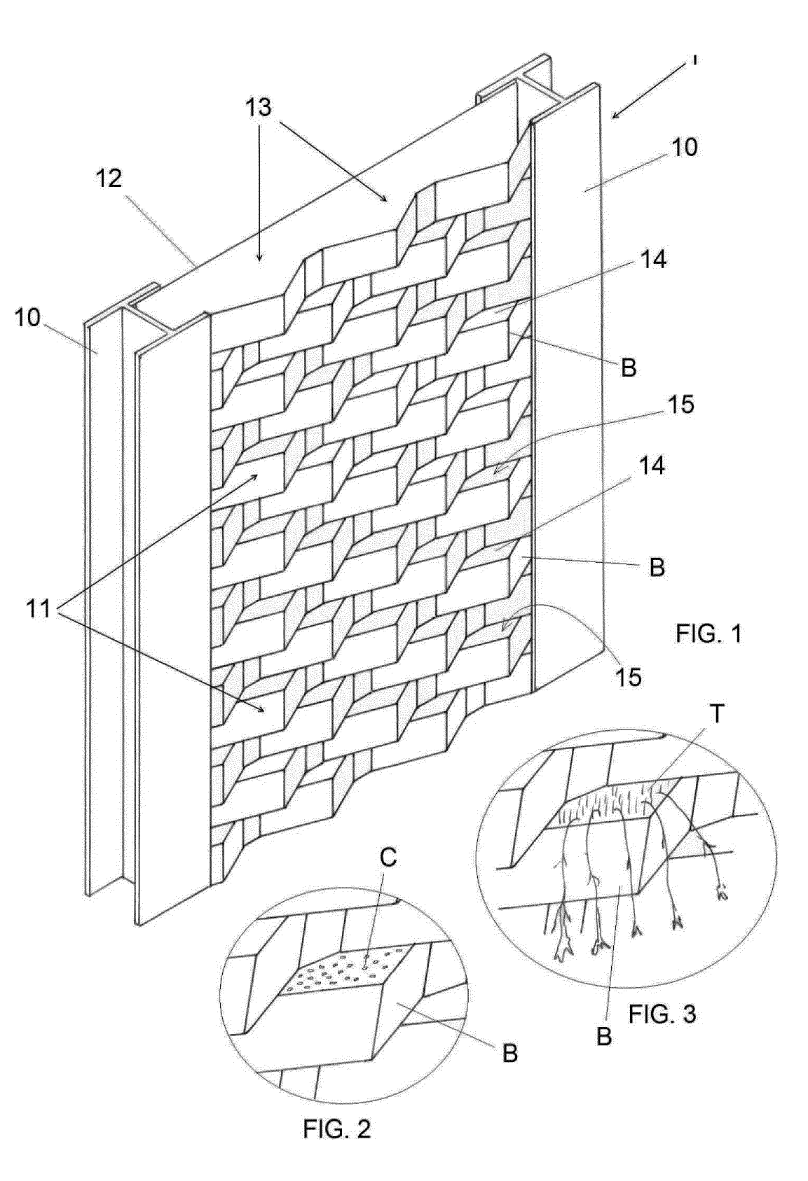

FIG. 1 is an axonometric view of the formwork according to the invention;

FIGS. 2 and 3 are partial enlarged views of the formwork of FIG. 1, diagrammatically showing two alternative uses of the formwork.

With reference to FIG. 1, the prefabricated formwork (1) has a panel-like structure. The formwork (1) comprises a pair of uprights (10), a front vertical wall (11) and a back vertical wall (12).

The uprights (10) are preferably metal sections, which can indifferently have a “C”, “H”, double-“T” or square section. The front and the back vertical walls (11, 12) have lateral borders fixed to the uprights (10) in such manner to define a cavity (13).

The front vertical wall (11) comprises a metal plate (steel or aluminum) comprising a plurality of projections (B) that protrude frontally from the metal plate in such manner to define pockets (15). Each projection (B) has a horizontal slot (14) disposed above the projection to access the pocket (15) defined by the projection. The pockets (15) are in communication with the cavity (13).

Preferably said front vertical wall (11) is obtained with a metal plate that undergoes an expansion process to obtain the projections (B) and the pockets (15).

Advantageously, each projection (B) is shaped as an outwards-protruding wedge, i.e. each projection (B) is shaped has an equilateral triangle or a trapezium in horizontal section.

Advantageously, the projections (B) are disposed along horizontal rows disposed in staggered position, in such manner that the horizontal slots (14) of all pockets (15) can be accessed by a user. Each row of projections (B) is shaped as a triangular or square wave in horizontal section and the adjacent rows are staggered by a half-cycle.

When the formwork (1) is used as a partition between two spaces that are accessible to people, both vertical walls (11, 12) of the formwork are intended to remain visible. In such a case, also the back vertical wall (12) advantageously comprises a metal plate provided with a plurality of projections (B) that protrude from the metal plate in such manner to define pockets (15) that are accessible from horizontal slots (14).

Alternatively, the back vertical wall (12) can comprise a flat metal plate, in case it is not intended to remain visible.

With reference to FIG. 2, the formwork (1) can be used as a container to contain a concrete casting in fluid state, in order to let the concrete set for the construction of masonry works. In this case, the cavity (13) of the formwork (1) is filled with concrete (C) in such manner that the concrete (C) also fills the pockets (15) in communication with the cavity (13). In this case, the concrete (C) contained in the pockets (15) can be seen from the horizontal slots (14) of the pockets (15). To avoid the unpleasant aesthetical impact of concrete, the upper portion of the pockets (15) can be filled with colored inert material that is poured in the pockets (15) through the horizontal slots (14) and is disposed on the concrete.

As shown in FIG. 3, the formwork (1) can be also used to contain soil (T) to make vertical gardens. In this case, the cavity (13) of the formwork (1) is filled with soil (T), in such manner that the soil (T) also fills the pockets (15) in communication with the cavity (13). In this way, the pockets (15) acts as pots used to grow plants that are intended to flourish out of the pockets (15) until the external surface of the vertical wall (11, 12) of the formwork (1) is either completely or partially covered.

It must be considered that the formwork (1) is of disposable type. In fact, in both uses of the formwork (1), all parts (uprights (10) and vertical walls (11, 12)) are intended to be permanently embedded in the structure formed by the formwork without the possibility of separating or removing said parts, as in the case of traditional modular (reusable) formworks after the filling and setting of the concrete.

The formworks (1) of the invention can be disposed in vertical rows, stacked one on top of the other, or in horizontal rows, positioned one next to the other. In order to keep together the formworks (1) disposed in horizontal or vertical rows, plate-shaped tie-rods such as the ones used to assemble the modular formworks of the prior art.

Preferably, each plate tie-rod is interposed between the adjacent edges of two formworks (1), in such manner to be embedded in the concrete casting or in the soil.

Advantageously, in the case of horizontal or vertical rows of formworks, reinforcing irons are disposed in the cavities (13) of the formworks (1). In this way the reinforcing irons are embedded in the concrete cast or in the soil disposed in the cavity of the formwork in such manner to improve the connection between adjacent formworks.

1. Prefabricated formwork comprising:
a pair of uprights,
a front vertical wall and a back vertical wall with lateral edges fixed to the uprights in such manner to define a cavity that is open on top and on the bottom;
wherein
said front vertical wall comprises a metal plate comprising with a plurality of projections that protrude frontally from the metal plate in such manner to define pockets, wherein each projection has a horizontal slot disposed above the projection to access the pocket defined by the projection.

2. The formwork of claim 1, wherein said back vertical wall comprises a metal plate comprising a plurality of projections that protrude on the back from the metal plate in such manner to define pockets, wherein each projection has a horizontal slot disposed above the projection in order to access the pocket defined by the projection.

3. The formwork of claim 1, wherein said front vertical wall is made of expanded metal plate and said uprights are metal sections.

4. The formwork of claim 2, wherein said back vertical wall is made of expanded metal plate and said uprights are metal sections.

5. The formwork of claim 1, wherein said cavity of the formwork contains concrete.

6. The formwork of claim 1, wherein said cavity contains soil so that said pockets can act as pots for growing plants.

7. The formwork of claim 1, wherein said pockets formed by the projections are in communication with said cavity formed between the two vertical walls of the formwork,

8. The formwork of claim 1, wherein each projection is shaped as an outward-protruding wedge.

9. The formwork of claim 1, wherein said front vertical wall comprises a plurality of horizontal rows of projections disposed in staggered position so that said horizontal slots of the pockets can be accessed by the user.

10. The formwork of claim 2, wherein said back vertical wall comprises a plurality of horizontal rows of projections disposed in staggered position so that said horizontal slots of the pockets can be accessed by the user.
